(19) United States
(12) Patent Application Publication
(10) Pub. No.: US 2026/0320948 A1
(43) Pub. Date: Oct. 15, 2026

(54) METHOD FOR GENERATING ACOUSTIC ARTIFICIAL HEAD MODEL WITH AURICLES BASED ON STATISTICAL SHAPE MODEL

(71) Applicant: SOUTH CHINA UNIVERSITY OF TECHNOLOGY, Guangzhou (CN)

(72) Inventors: Guangzheng YU, Guangzhou (CN); Yewei WANG, Guangzhou (CN); Wei TAN, Guangzhou (CN); Zhelin LI, Guangzhou (CN)

(73) Assignee: SOUTH CHINA UNIVERSITY OF TECHNOLOGY, Guangzhou (CN)

(21) Appl. No.: 19/577,375

(22) Filed: Mar. 25, 2026

Related U.S. Application Data
(63) Continuation of application No. PCT/CN2024/106970, filed on Jul. 23, 2024.

(30) Foreign Application Priority Data
Sep. 25, 2023 (CN) 202311242438.6

(51) Int. Cl. G06T 19/20; B29C 45/00; B33Y 10/00; G06T 5/70; G06T 17/00

(52) U.S. Cl. CPC G06T 19/20; B29C 45/00; B33Y 10/00; G06T 5/70; G06T 17/00

(57) ABSTRACT

Present invention discloses a method for generating acoustic artificial head model with auricles based on statistical shape model, including following steps: preprocessing a 3D model database of a complete head surface of a subject, and then splitting the preprocessed 3D model database into an auricle-free head model dataset and an extended auricle model dataset that have selected regions; in a rigidly aligned coordinate system, using the statistical shape model to respectively generate a corresponding auricle-free head average model and a corresponding extended auricle average model, where the two models are notably featured with index information of the selected regions; and merging the auricle-free head average model and the extended auricle average model based on the selected regions to generate a complete external contour model of the acoustic artificial head model with auricles, where the contour model is used for designing and fabricating an acoustic artificial head model entity.

### CROSS-REFERENCE TO RELATED APPLICATION

This application is a continuation of international application of PCT application serial no. PCT/CN2024/106970, filed on Jul. 23, 2024, which claims the priority benefits of China Application No. 202311242438.6, filed on Sep. 25, 2023. The entirety of each of the above-mentioned patent applications is hereby incorporated by reference herein and made a part of this specification.

### TECHNICAL FIELD

This application relates to the field of acoustic technology, and in particular, to a method for generating an acoustic artificial head model with auricles based on a statistical shape model.

### BACKGROUND

Humans perceive sound information through both ears, and binaural sound pressure signals include the main information of sound. From a physical perspective, sound waves emitted by a sound source reach both ears after being reflected and scattered by the surface of the human body (Xie B. Head-related transfer function and virtual auditory display [M]. National Defence Industry Press, 2008.), so the shape of the human body has a significant impact on the sound information received.

In the field of acoustic technology, sound pressure signals collected by both ears can be directly used for binaural sound reproduction research, or head-related transfer functions (HRTFs) can be obtained from binaural signals in an anechoic chamber and their binaural localization factors can be extracted for virtual auditory reproduction research, which has important application prospects in fields such as virtual reality (Xie B. Head-related transfer function and virtual auditory display [M]. J. Ross Publishing, 2013.). However, an experimental measurement process is cumbersome, and experimental conditions have a non-negligible effect on data accuracy (Li S, Peissig J. Measurement of head-related transfer functions: A review [J]. Applied Sciences, 2020, 10 (14): 5014.), therefore, acquisition of binaural acoustic signals through numerical simulation is also a successful application. Based on 3D models, binaural acoustic signals under different acoustic environments and sound source positions can be conveniently obtained (Katz B F G. Boundary element method calculation of individual head-related transfer function. I. Rigid model calculation [J]. The Journal of the Acoustical Society of America, 2001, 110 (5): 2440-2448.). This technology has a broad application prospect and has become a research focus in the interdisciplinary field of acoustics with the development of 3D imaging and 3D printing technologies.

Furthermore, based on 3D models of head shapes of a large number of subjects, universal artificial head models are generated using various methods, which greatly facilitates research on virtual auditory reproduction and binaural hearing. There are numerous existing artificial heads with different uses and design methods. Some representative artificial head information is listed in Table 1 below:

TABLE 1
Existing artificial heads and design methods thereof

| | | | | Whether merging |
|---|---|---|---|---|
| | | Whether a | Whether | is performed |
| | With refined | statistical | the auricle | based on the |
| | auricle | shape model | is | selected region of |
| Artificial | (or) simplified | is used for | designed | the extended |
| head name | auricle | design | separately | auricle |
| KEMAR | Refined auricle | x | ✓ | x |
| B&K | Refined auricle | x | ✓ | x |
| HAT | Simplified auricle | x | ✓ | x |
| NeumannKU | Refined auricle | x | ✓ | x |
| 100 | | | | |

Through literature research, it is found that existing artificial heads have not disclosed their design concepts and technical details. In particular, it can be determined that none of the existing artificial heads involve a coupling relationship between the auricle and the head surface (coupling state parameters, such as auricle opening angle θ.). Among the existing artificial heads, the auricle and head physiological structure features of the KEMAR artificial head are most similar to the solution of this patent, but its official documentation only provides reference physiological structure dimensions of European populations without disclosing its specific design solution or technical details. However, for the head-related transfer function that is extremely important for binaural hearing research (which is defined as the acoustic transfer process of sound waves from a free-field point sound source to both ears, including most of sound source localization information and serving as an important data basis for virtual auditory reproduction), there are very significant individual differences in auricle structural features, dimensional parameters, auricle opening angle, rotation angle, and the like, all of which have a significant impact on the head-related transfer function. Therefore, in applications of artificial heads related to acoustics and hearing, retaining more representative auricle structural features and coupling morphological parameters between the auricles and the head surface is of great scientific significance and application value.

Due to the complexity of auricle morphology, the auricle models of existing artificial heads are generated only through limited-dimensional data for local auricle design. However, a significant advantage of the present invention is that high-order geometric features of the auricles and the adjacent head surfaces are incorporated in the adopted method, enabling complete morphological parameters such as auricle structural features and auricle opening angle to be embodied in the model. In practical applications involving acoustic artificial heads, retaining morphological parameters of the auricle coupled to the head, such as the auricle opening angle, is of great significance for binaural acoustic signal feature analysis and binaural auditory localization factor research. Therefore, the present invention can generate artificial head models more suitable for acoustics research, and has scientific significance and application prospects.

### SUMMARY

To effectively retain more personalized auricular structures and morphological parameters of auricles coupled to a head surface, the present invention provides a method for generating an acoustic artificial head model based on a statistical shape model. The method is suitable for designing acoustic artificial head models for binaural hearing research. The method is proposed to retain the complex physiological structural features of auricular local regions, a coupling relationship between the auricles and the head, and morphological parameters of the aural region such as auricle opening angle in practical applications of acoustic artificial heads, which has great significance for binaural acoustic signal feature analysis and binaural auditory localization factor research. In view of current difficulties in artificial head models in rapidly and accurately capturing population-specific auricular models, a method for generating an acoustic artificial head model with auricles based on a statistical shape model is provided.

The present invention is implemented by at least one of the following technical solutions.

A method for generating an acoustic artificial head model with auricles based on a statistical shape model is provided, and includes the following steps:
(1) preprocessing a 3D model database of a complete head surface of a subject, and then splitting the preprocessed 3D model database into an auricle-free head model dataset and an extended auricle model dataset which have selected regions;
(2) in a rigidly aligned coordinate system, using a statistical shape model method to respectively generate a corresponding auricle-free head average model M_{H} and a corresponding extended auricle average model M_{P}, where wherein the two models include index information of the selected regions; and
(3) merging the auricle-free head average model M_{H} and the extended auricle average model M_{P} based on the selected regions and corresponding index information to generate a complete external contour model M_{HP} of the acoustic artificial head model with auricles, where the external contour model M_{HP} is used for designing and fabricating an acoustic artificial head model entity.

Furthermore, in Step (1), the number of subjects meets modeling requirements, all complete head models are marked and rigidly aligned such that feature points defined by physiological structures on all the models are located at a same position in a space, that is, feature-point marking is performed, and non-rigid registration is performed to obtain a complete head dataset, thereby eliminating data errors caused by translational or rotational differences.

Furthermore, the preprocessing includes noise removal, filling of missing data points, and planar cross-section closure processing at the neck.

Furthermore, an auricle notch of the auricle-free head model is an auricle root; an outer boundary of the selected region is a conical surface having an opening angle, and originating from the center of the head and along a binaural polar axis direction, forming a closed loop notch with head surfaces near the auricles; the closed loop notch is set as a radius R′, and the radius R′ is greater than a maximum radius Rₘₐₓ of the auricle projected on the head surface in the binaural polar axis direction, namely, R′>Rₘₐₓ, to ensure that the intercepted extended auricle model has complete shape features; and the selected region is a region between an auricle root notch and the closed loop notch.

Furthermore, in Step (2), in the auricle-free head model dataset and the extended auricle model dataset, which have undergone rigid alignment and non-rigid registration in Step (1), auricle-free head data and extended auricle data are used to establish statistical shape models of an auricle-free head/extended auricle via Gaussian processes respectively, describing and constraining a reasonable probability distribution range of complete model contours; and average functions of the statistical shape models are calculated to obtain the auricle-free head average model M_{H} and the extended auricle average model M_{P}.

Furthermore, the merging is performed based on the auricle-free head model dataset and the extended auricle model dataset obtained from preprocessing in Step (1), vector superposition coupling is performed on the auricle-free head average model M_{H} and the extended auricle average model M_{P} using the index information between the two datasets provided by the selected regions and thus the merging is completed; during merging, a model edge is filtered and smoothed to generate the complete external contour model M_{HP} of the acoustic artificial head model with auricles.

Furthermore, during merging, using the selected region of the auricle-free head average model M_{H} as a benchmark, a mesh density of the auricle-free head average model M_{H} in the selected region should be equal to a mesh density of the extended auricle average model M_{P} in the selected region.

Furthermore, a mesh size of the extended auricle average model M_{P} is not greater than one-sixth of a wavelength of sound waves at 20 kHz which is an upper limit frequency of audible sound.

Furthermore, a hollow or solid entity of the external contour model M_{HP} of the acoustic artificial head model with auricles is fabricated through shelling and offset design for the model.

Furthermore, a hollow or solid entity of the external contour model M_{HP} of the acoustic artificial head model with auricles is fabricated by injection molding, mold casting, and 3D printing methods.

Compared with the prior art, the beneficial effects of the present invention are that:
(1) local physiological features of the auricles are aligned, so that a structure of the obtained extended auricle average model M_{P} is more accurate and representative; and
(2) higher-order geometric features of the auricles and the adjacent selected region are retained, enabling complete morphological parameters such as auricle opening angle to be represented in the model. In binaural acoustic signal feature analysis and binaural auditory localization factor research, structural features of and morphological parameters of the auricles are of great significance. Since the present invention better retains the structural features of and the morphological parameters of the auricles, the acoustic artificial head designed by the present invention is more representative and practical than traditional artificial heads. The accuracy and representativeness of the acoustic artificial head designed by the present invention are significantly superior to those of the traditional artificial heads.

### BRIEF DESCRIPTION OF THE DRAWINGS

FIG. 1 is a flowchart of a method for generating an acoustic artificial head model with auricles based on a statistical shape model according to an embodiment;

FIG. 2 is a schematic diagram of a partial section of a complete head model according to an embodiment;

FIG. 3 is a schematic diagram of a partial section of an auricle-free head model only after auricle removal according to an embodiment;

FIG. 4 is a cross-sectional schematic diagram of an extended auricle model according to an embodiment;

FIG. 5 is an effect diagram of auricle separation on a head contour using a conical closed-loop notch according to an embodiment;

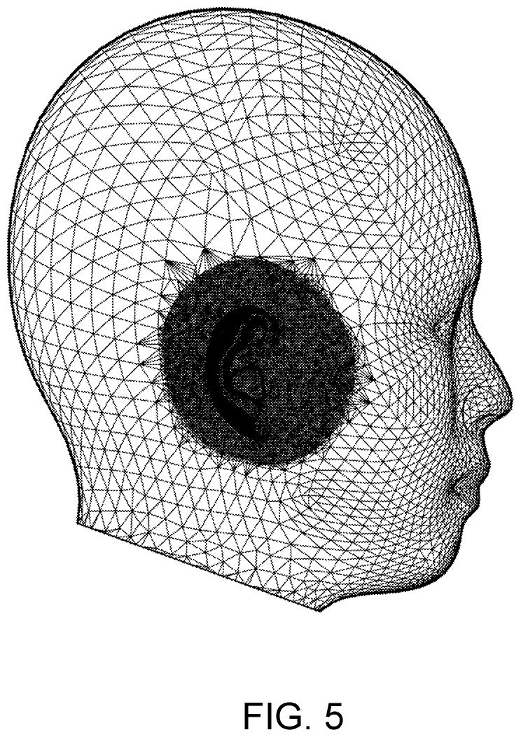

FIG. 6 is a merging effect diagram according to an embodiment; and

FIG. 7A, FIG. 7B, FIG. 7C and FIG. 7D are comparison diagrams between an artificial head model obtained by the present invention and an artificial head obtained by a previous method according to an embodiment.

### DESCRIPTION OF THE EMBODIMENTS

Specific embodiments of the present invention are further described below with reference to the accompanying drawings and embodiments. The following embodiments are intended to illustrate the present invention, instead of limiting the scope of the present invention.

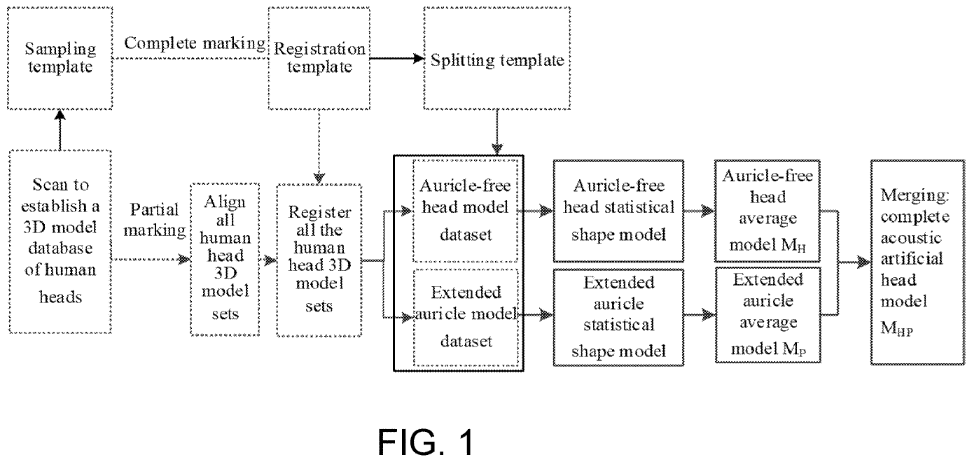

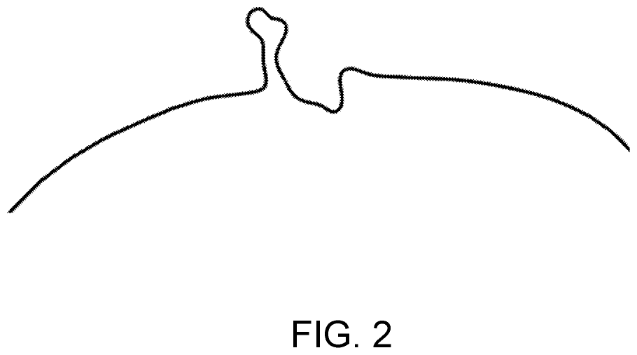

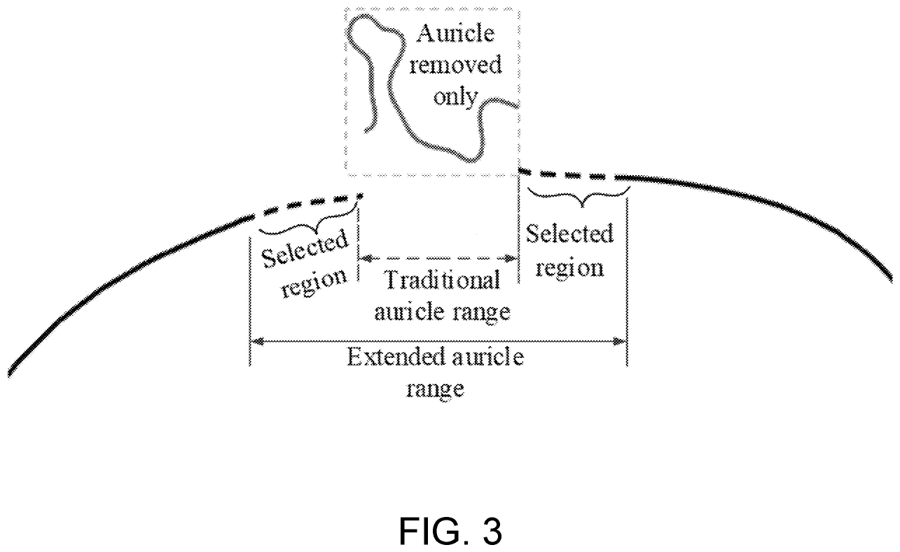

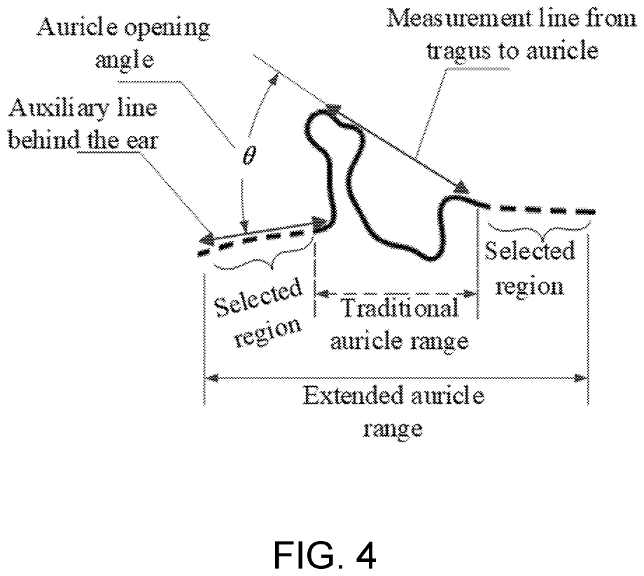

In the present invention, a preprocessed basic database of human head models (refer to FIG. 2 for a partial sectional contour) is split into a dataset of auricle-free head models (refer to FIG. 3 for a partial sectional contour) and a dataset of extended auricle models (refer to FIG. 4) that have selected regions; an auricle-free head average model (model M_{H}) and an extended auricle average model (model M_{P}) are established by using a statistical shape model method; and finally, based on the selected regions, the two average models are merged to generate a complete artificial head model (model M_{HP}) that can be used to simulate acoustic (sound wave) signals (namely, sound wave signals propagating from a specific sound source to both ears) received by both ears. After shelling and other design steps, a complete 3D acoustic artificial head model can also be obtained; and entity models thereof can be fabricated by using various methods including but not limited to injection molding and 3D printing technologies. An implementation process is as shown in FIG. 1 and mainly includes: Step (1): preprocessing a 3D model database of a complete head surface of a certain number of subjects, and then splitting the preprocessed 3D model database into an auricle-free head model dataset and an extended auricle model dataset which have selected regions; Step (2): in a rigidly aligned coordinate system, using the statistical shape model to respectively generate a corresponding auricle-free head average model M_{H} and a corresponding extended auricle average model M_{P}, where the two models include index information of the selected regions; and Step (3): merging the model M_{H} and the model M_{P} based on the selected regions and corresponding index information to generate a complete external contour model M_{HP} of the acoustic artificial head model with auricles, where the contour model is used for designing and fabricating an acoustic artificial head model entity. The present invention aims to design an acoustic artificial head model suitable for binaural hearing research, and in particular, the method of the present invention can effectively retain more representative auricle contour shape features and a relative positional relationship between the auricles and a head surface.

As shown in FIG. 1, this embodiment shows a complete process flow for generating an acoustic artificial head model with auricles, and the process flow is also suitable for a method for generating an acoustic artificial head model with auricles based on a statistical shape model described in this embodiment. Specific steps thereof include:

Step 1: Establish a basic database, perform preprocessing on the basic database, and respectively generate an auricle-free head model dataset and an extended auricle model dataset.

Step 1.1: Use a 3D scanner or other imaging devices to acquire 3D head scanning data from multiple individuals; and perform preprocessing on the acquired data through thereby establishing a basic database. The preprocessing includes noise removal, filling of missing data points, and planar cross-section closure processing at the neck. All the acquired data need to be acquired with the prior consent of the subjects and meet ethical review requirements.

Specifically, a database size should generally satisfy the following statistical requirements:

It is assumed that the basic database has been acquired, the sample volume of the database should comply with ISO 15535:2007 standard to ensure the reliability of results. A limiting formula is as follows:

$$N = {( \frac{1.96 \times C V}{a} )}^{2} \times 1.53 {4}^{2} \qquad ( 1 )$$

$$CV = \frac{SD}{\overline{X}} \qquad ( 2 )$$

where 1.96 represents a key value of a 95% confidence interval for standard normal distribution (Z value); CV represents an average deviation coefficient; SD represents a standard deviation of an investigated human body dimension; α represents desired relative accuracy of investigation, X̅ represents an average dimension; here, data of a maximum head length is used to obtain a minimum capacity N of a largest sample. It should be noted that the preprocessing need to be performed on models that have completed marking, alignment, and registration.

Step 1.2: Establish a registration template and a splitting template.

Step 1.2.1: Establish the registration template. A representative human head model is sampled as an initial template shape, and physiological features of the initial template shape are completely marked. Complete physiological feature markers need to include all detailed features such as face, neck, head contour, and auricle, thereby generating the registration template with corresponding relationships to the physiological features.

Step 1.2.2: Split the template. Performing region division for the registration template obtained in Step 1.2.1 and the registration template is divided into three regions: an auricle region, a selected region, and the remaining head regions. An auricle notch of the auricle-free head model is an auricle root (refer to FIG. 3); an outer boundary of the selected region is a conical surface having a specific opening angle, and originating from the center of the head and along a binaural polar axis direction, forming a closed loop notch (radius R′) with head surfaces near the auricles, where the radius is greater than a maximum radius Rₘₐₓ of the auricle projected on the head surface in the binaural polar axis direction, namely, R′>Rₘₐₓ, to ensure that the intercepted extended auricle model has complete shape features; and the selected region is a region between an auricle root notch and the closed loop notch (refer to FIG. 3 and FIG. 4).

As a specific embodiment, a human Frankfurt plane is established based on left and right tragus points and a right infraorbital margin point, and a coordinate system is established based on a human head symmetry plane and a line connecting ear canal openings; then, with the line connecting ear canal openings as a central axis and the origin of the coordinate system as the vertex, left-right symmetric conical surfaces are created at a 30° inclination angle (the auricles are generally within an 20° inclination angle in the binaural polar axis originating from the center of the head), thus defining the outer boundary of the selected region (with a side away from the central axis as the outer boundary). Meanwhile, the auricle root notch is used as the inner boundary of the selected region, thereby completing the definition of the selected region that the selected region is a region between the auricle root notch and the closed-loop notch. The auricle region is defined as the auricle model within the auricle root notch, while the remaining head region refers to the region of the complete head model excluding the auricle region, namely, the region outside the closed-loop notch. The union of the auricle region and the selected region constitutes the extended auricle region, and union of the remaining head regions and the selected region constitutes the auricle-free head region; and the part corresponding to the template is the extended auricle model and the auricle-free head model, and the corresponding point cloud index is the data form of point cloud region division.

Step 1.3: Perform marking, alignment, and registration of all models in the database.

Step 1.3.1: Marking. Perform marking on some key physiological features on all human head models with reference to anatomical knowledge. Compared to complete marking in Step 1.2.1, only some key feature points need to be marked here, where the key features include feature points of an ear canal opening, the left and right tragus points, and the right infraorbital margin point.

Step 1.3.2: Alignment. The human Frankfurt plane is established based on the left and right tragus points and the right infraorbital margin point, and the coordinate system is established based on the human head symmetry plane and the line connecting ear canal openings. Performing rigid alignment on the models such that all the head models are located on a same position in a space based on physiological structure definitions, thereby eliminating data errors caused by translational or rotational differences.

Step 1.3.3: Registration. According to the obtained physiological structure feature points and the non-rigid iterative closest point (NICP) registration algorithm, the head model surface data is registered based on the template to obtain a point distribution model with corresponding relationships, thereby generating a complete model dataset.

Step 1.4: Split the dataset based on the template to establish the auricle-free head model dataset and the extended auricle model dataset, and define the selected region.

Step 1.4.1: Establish the auricle-free head model dataset. Based on the auricle-free head model index obtained in Step 1.2.2, extract the auricle-free head model dataset from the complete head model sets that have been aligned and registered in Step 1.3.

Step 1.4.2: Based on the extended auricle model index obtained in Step 1.2.2, extract the extended auricle model dataset from the complete head model sets that have been aligned and registered in Step 1.3.

As an embodiment, the mesh size of the extended auricle model should be less than one-sixth of the minimum audible sound wavelength, namely, 2.8 mm, to fully describe the structure of the human extended auricle; the non-extended auricle model (the part excluding the extended auricle model) should include the basic features of the human head, and the non-key structures are omitted. Refer to FIG. 3 for a schematic diagram of relevant processing effects.

Step 2: Establish a statistical shape model and obtain an average model.

Step 2.1: Calculate the distributions and reference shapes of all points using the auricle-free head model dataset and extended auricle model dataset that have been aligned and registered and obtained in Step 1. For the dataset, spatial three-dimensional coordinates of surface points of the human body can be represented by a vector x_{i,j} For the ith subject, the surface shape Γᵢ of the human body can be discretely represented by the human-body surface shape vector Sᵢ (a set of vectors x_{i,j}∈R³ on the physiological structure) as follows:

$${x}_{i , j} = ( {x}_{i , j}^{x} , {x}_{i , j}^{y} , {x}_{i , j}^{z} ) \qquad ( 3 )$$

$${S}_{i} = \{ {( {x}_{i , 1 ,} {x}_{i , 2} , … , {x}_{i , p} )}^{T} \vert {x}_{i , j} ∈ {Γ}_{i} \} = ( {x}_{i , 1}^{x} , {x}_{i , 1}^{y} , {x}_{i , 1}^{z} , … , {x}_{i , p}^{x} , {x}_{i , p}^{y} , {x}_{i , p}^{z} ) \qquad ( 4 )$$

In formula

$${x}_{i , j}^{x} , {x}_{i , j}^{y} , {x}_{i , j}^{z} ,$$

superscripts x, y, z represent corresponding spatial coordinates, subscript i represents the subject number, j represents the point number, p represents the total number of template points, R³ indicates a vector dimension being 3, and

$${x}_{i , p}^{x} , {x}_{i , p}^{y} , {x}_{i , p}^{z}$$

represents x, y, z coordinates of a last point in the model.

Based on the human-body surface shape vector Sᵢ of each subject sample shown in formula (4), the datasets can be integrated.

Statistically, the category of shapes is usually modeled by a multivariate normal distribution N (μ, Σ). This is determined by the assumption that when the sample volume is sufficiently large, any variable of the shape vector S follows a normal distribution. The human-body surface shape vectors S of all N subjects in the auricle-free head model dataset or the extended auricle model dataset are averaged, the average human-body surface shape vector μ and the covariance matrix Σ thereof can be calculated, and S~N (μ, Σ), that is a point distribution model that describes the distribution state of model points. Based on this, the average human-body surface shape vector μ can be considered to represent a reference shape Γ_{R}:

$$μ = \frac{1}{N} {\sum }_{i = 1}^{N} {S}_{i} \qquad ( 5 )$$

$$Σ = {\sum }_{i = 1}^{N} ( {S}_{i} - μ ) {( {S}_{i} - μ )}^{T} \qquad ( 6 )$$

in the formula, N represents the total number of subjects.

Step 2.2: Establish a Gaussian process. Through the vector Sᵢ in Step 2.1, a set of discrete functions sᵢ(xₖ) can be defined on Γ_{R}, where the function sᵢ(xₖ) represents the kth value of the vector Sᵢ for the ith subject, and s(x) represents a mapping relationship from any variable x on the reference shape Γ_{R} to the corresponding variable x on another shape Γ. The Gaussian process shown in formula (7) is uniquely defined by the average function μ (x) described in formula (8) and the covariance function Σ(x, x′) described in formula (9):

$${\{ ( {x}_{k} , s ( {x}_{k} ) ) \vert {x}_{k} ∈ {Γ}_{R} , s ( {x}_{k} ) ∈ Γ \}}_{k = 1}^{m} , s ( x ) \sim GP ( μ ( x ) , Σ ( x , {x}^{′} ) ) \qquad ( 7 )$$

$$μ ( x ) = \frac{1}{N} {\sum }_{i = 1}^{N} {s}_{i} ( x ) \qquad ( 8 )$$

$$Σ ( x , {x}^{′} ) = {\sum }_{i = 1}^{N} ( {s}_{i} ( x ) - μ ( x ) ) {( {s}_{i} ( {x}^{′} ) - μ ( x ) )}^{T} \qquad ( 9 )$$

In the formula, xₖ represents the kth variable on the reference shape Γ_{R}, and specifically indicates any spatial coordinate of any point on the template; m represents the total number of variables in the template, equaling the total number of template points multiplied by 3, namely, m=3p; GP is the abbreviation for the Gaussian Process, and can also be modified to N to represent the normal distribution; x indicates a continuous form of xₖ and represents any variable at any point on ΓR; x′ represents a point different from x. sᵢ(x) represents mapping from the reference shape Γ_{R} to the shape of the ith subject; sᵢ(x) represents mapping from the reference shape Γ_{R} to the shape of the ith subject.

Karhunen-Loève expansion is performed on the covariance function Σ(x, x′) to obtain a set of orthogonal basis functions φᵢ(x) and corresponding eigenvalues λᵢ. The coefficient αᵢ is introduced so that s(x) can be described in the following formula:

$$s ( x ) \sim μ ( x ) + {\sum }_{i = 1}^{∞} {α}_{i} \sqrt{{λ}_{i}} {ϕ}_{i} ( x ) , {α}_{i} \sim N ( 0 , 1 ) \qquad ( 11 )$$

Similar to principal component analysis, the low-order approximation item is retained as follows:

$$\tilde{s} ( x ) \sim μ ( x ) + {\sum }_{i = 1}^{r} {α}_{i} \sqrt{{λ}_{i}} {ϕ}_{i} ( x ) \qquad ( 12 )$$

in the formula, r represents an order required for the low-order approximation of s(x).

The approximate values \tilde{φ}ᵢ(x) of the above basis functions φᵢ(x) can be calculated by using the Nyström method, and finally the shape is represented as:

$$\overline{S} = {( μ ( {x}_{1}^{x} ) , μ ( {x}_{1}^{y} ) , μ ( {x}_{1}^{z} ) , … , μ ( {x}_{p}^{x} ) , μ ( {x}_{p}^{y} ) , μ ( {x}_{p}^{z} ) )}^{T} \qquad ( 13 )$$

$${u}_{i} = {( {\tilde{ϕ}}_{i} ( {x}_{1}^{x} ) , {\tilde{ϕ}}_{i} ( {x}_{1}^{y} ) , {\tilde{ϕ}}_{i} ( {x}_{1}^{z} ) , … , {\tilde{ϕ}}_{i} ( {x}_{p}^{x} ) , {\tilde{ϕ}}_{i} ( {x}_{p}^{y} ) , {\tilde{ϕ}}_{i} ( {x}_{p}^{z} ) )}^{T} \qquad ( 14 )$$

$$S = \overline{S} + {\sum }_{i = 1}^{n} {α}_{i} \sqrt{{λ}_{i}} {u}_{i} = \overline{S} + Q a \qquad ( 15 )$$

in the formula, p represents the total number of template points,

$$μ ( {x}_{p}^{x} ) , μ ( {x}_{p}^{y} ) , μ ( {x}_{p}^{z} )$$

represents spatial coordinates x, y, z of the pth point on the template mapped to the average function μ(x),

$${\tilde{ϕ}}_{i} ( {x}_{p}^{x} ) , {\tilde{ϕ}}_{i} ( {x}_{p}^{y} ) , {\tilde{ϕ}}_{i} ( {x}_{p}^{z} )$$

represents spatial coordinates x, y, z of the pth point on the template mapped to the approximate value of the above basis function õᵢ(x). S represents any human-body surface shape vector; Q is a feature matrix; and α represents a coefficient vector corresponding to the feature matrix.

Formula (15) refers to decomposition of any shape into a linear combination of the average shape S̅ and a set of feature shape variation modes uᵢ, and any shape can be represented by the coefficient vector. When the method is applied to the complete head model dataset and the complete extended auricle model dataset respectively, the auricle-free head average model M_{H} and the extended auricle average model M_{P} can be obtained.

The corresponding auricle-free head average model M_{H} and the corresponding extended auricle average model M_{P} are generated, including but not limited to the auricle-free head average model M_{H} and the extended auricle average model M_{P} that are obtained by a same method based on any subset from the auricle-free head model dataset and the extended auricle model dataset and are used for designing and fabricating the acoustic artificial head model entities.

Step 3: Merge the auricle-free head average model M_{H} and the extended auricle average model M_{P} based on the selected regions and corresponding index information to generate a complete external contour model M_{HP} of the acoustic artificial head model with auricles.

Step 3.1: The point cloud data of the selected regions in the auricle-free head average model M_{H} and the extended auricle average model M_{P} are denoted as P_{H} and P_{P}, respectively. Using the auricle-free head average model M_{H} as a benchmark, a conversion matrix Tis calculated based on a minimum average square error, by which the model M_{H} is overlapped with model M_{P}.

$$\begin{matrix}{P}_{H} \approx {TP}_{P} \\ {M}_{P}^{′} = {TM}_{P}\end{matrix} \qquad ( 16 )$$

Here,

$${M}_{P}^{′}$$

represents the transformed extended auricle average model M_{P}.

Step 3.2: Design a filtering matrix W to perform linear filtering on the margin of the point cloud data P_{H} in the selected regions, thereby smoothing the template.

$${WP}_{H} = \frac{1}{n} {\sum }_{i = 1}^{n} [ {ω}_{i} {P}_{H} + ( 1 - {ω}_{i} ) {TP}_{P} ] \qquad ( 17 )$$

in the formula, ωᵢ represents a weighting coefficient and is used for weighted summation of the matrix.

Step 3.3: Perform vector superposition on the models. Specifically, superimpose the auricle-free head average model M_{H} onto the transformed extended auricle average model

$${M}_{P}^{′} ,$$

and then add the selected region WP_{H} for filtering to achieve coupling of the auricle-free head average model M_{H} and the extended auricle average model M_{P}, where the resulting target shape M_{HP} is expressed as:

$${M}_{HP} = {WM}_{H} + {M}_{P}^{′} + {M}_{H} \qquad ( 18 )$$

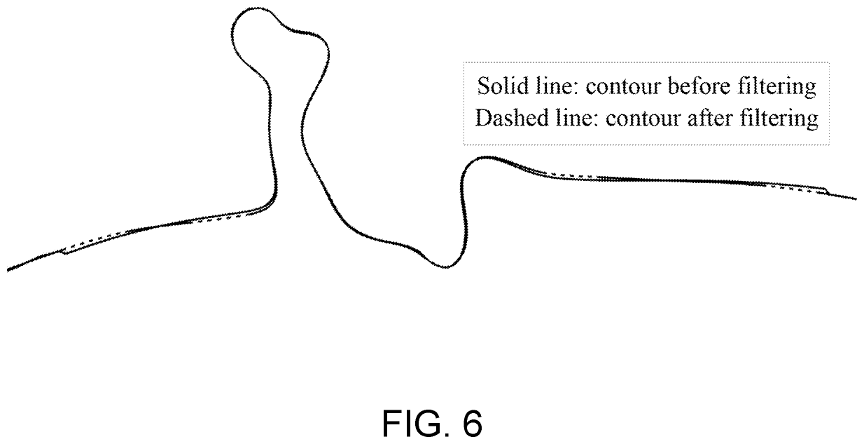

The target shape M_{HP} refers to the external contour of the acoustic artificial head model with auricles. The filtering and smoothing effects are shown in FIG. 6.

Based on the statistical shape model, the external contour model M_{HP} of the acoustic artificial head model with auricles is generated and used for designing and fabricating the acoustic artificial head model entities through methods including but not limited shelling, offsetting, injection molding, mold casting, and 3D printing. The hollow or solid model is designed for entity fabrication.

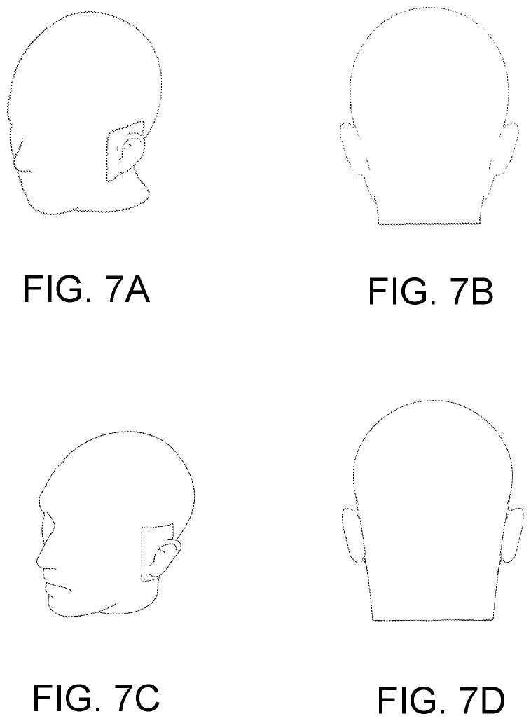

FIG. 7C and FIG. 7D show KEMAR artificial heads produced abroad that are widely used in acoustic measurement and other fields. The models are designed based on average physiological parameters of Western human bodies. A method of acquiring the shape of the artificial head (FIG. 7A and FIG. 7B) according to the present invention is fundamentally different from a method for acquiring population and KEMAR artificial heads. A comparison in FIG. 7A, FIG. 7B, FIG. 7C and FIG. 7D is only for the comparison of the shape, and an isometric view (FIG. 7A and FIG. 7C) and a rear view (FIG. 7B and FIG. 7D) are taken as an example.

The above are specific embodiments of the present invention. By means of key steps such as establishing a template with corresponding physiological features, constructing a statistical shape model, and generating the complete external contour of the acoustic artificial head model with auricles, the acoustic artificial head model with auricles is generated. This retains key physiological parameters such as auricle opening angle and solves a problem of traditional artificial head models in terms of fabricating auricle models, bringing substantial progress and application value to acoustic measurement and related research fields.

What is claimed is:

1. A method for generating an acoustic artificial head model with auricles based on a statistical shape model, comprising following steps:
(1) preprocessing a 3D model database of a complete head surface of a subject, and then splitting the preprocessed 3D model database into an auricle-free head model dataset and an extended auricle model dataset which have selected regions;
(2) in a rigidly aligned coordinate system, using a statistical shape model method to respectively generate a corresponding auricle-free head average model M_{H} and a corresponding extended auricle average model M_{P}, wherein the two models include index information of the selected regions; and
(3) merging the auricle-free head average model M_{H} and the extended auricle average model M_{P} based on the selected regions and corresponding index information to generate a complete external contour model M_{HP} of the acoustic artificial head model with auricles, wherein the external contour model M_{HP} is used for designing and fabricating an acoustic artificial head model entity.

2. The method for generating the acoustic artificial head model with auricles based on the statistical shape model according to claim 1, wherein in Step (1), a number of subjects meets modeling requirements, all complete head models are marked and rigidly aligned such that feature points defined by physiological structures on all the models are located at a same position in a space, that is, feature-point marking is performed, and non-rigid registration is performed to obtain a complete head dataset, thereby eliminating data errors caused by translational or rotational differences.

3. The method for generating the acoustic artificial head model with auricles based on the statistical shape model according to claim 1, wherein the preprocessing comprises noise removal, filling of missing data points, and planar cross-section closure processing at the neck.

4. The method for generating the acoustic artificial head model with auricles based on the statistical shape model according to claim 1, wherein an auricle notch of the auricle-free head model is an auricle root; an outer boundary of the selected region is a conical surface having an opening angle, and originating from a center of the head and along a binaural polar axis direction, forming a closed loop notch with head surfaces near the auricles; the closed loop notch is set as a radius R′, and the radius R′ is greater than a maximum radius Rₘₐₓ of the auricle projected on the head surface in the binaural polar axis direction, namely, R′>Rₘₐₓ, to ensure that the intercepted extended auricle model has complete shape features; and the selected region is a region between an auricle root notch and the closed loop notch.

5. The method for generating the acoustic artificial head model with auricles based on the statistical shape model according to claim 1, wherein in Step (2), in the auricle-free head model dataset and the extended auricle model dataset, which have undergone rigid alignment and non-rigid registration in Step (1), auricle-free head data and extended auricle data are used to establish statistical shape models of an auricle-free head/extended auricle via Gaussian processes respectively, describing and constraining a reasonable probability distribution range of complete model contours; and average functions of the statistical shape models are calculated to obtain the auricle-free head average model M_{H} and the extended auricle average model M_{P}.

6. The method for generating the acoustic artificial head model with auricles based on the statistical shape model according to claim 1, wherein the merging is performed based on is that based on the auricle-free head model dataset and the extended auricle model dataset obtained from preprocessing in Step (1), vector superposition coupling is performed on the auricle-free head average model M_{H} and the extended auricle average model M_{P} using the index information between the two datasets provided by the selected regions; during merging, a model edge is filtered and smoothed to generate the complete external contour model M_{HP} of the acoustic artificial head model with auricles.

7. The method for generating the acoustic artificial head model with auricles based on the statistical shape model according to claim 1, wherein during merging, using the selected region of the auricle-free head average model M_{H} as a benchmark, a mesh density of the auricle-free head average model M_{H} in the selected region should be equal to a mesh density of the extended auricle average model M_{P} in the selected region.

8. The method for generating the acoustic artificial head model with auricles based on the statistical shape model according to claim 1, wherein a mesh size of the extended auricle average model M_{P} is not greater than one-sixth of a wavelength of sound waves at 20 kHz which is an upper limit frequency of audible sound.

9. The method for generating the acoustic artificial head model with auricles based on the statistical shape model according to claim 1, wherein a hollow or solid entity of the external contour model M_{HP} of the acoustic artificial head model with auricles is fabricated through shelling and offset design for the model.

10. The method for generating the acoustic artificial head model with auricles based on the statistical shape model according to claim 1, wherein a hollow or solid entity of the external contour model M_{HP} of the acoustic artificial head model with auricles is fabricated by injection molding, mold casting, and 3D printing methods.
